(19) United States
(12) Patent Application Publication
(10) Pub. No.: US 2008/0180348 A1
(43) Pub. Date: Jul. 31, 2008

(54) Wireless Card and Adjustable Antenna of the Same

(75) Inventor: Gary Hsu, Linkou Township (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BANDRICH INC., Sindian City (TW)

(21) Appl. No.: 11/669,475

(22) Filed: Jan. 31, 2007

(51) Int. Cl. H01Q 1/42; H01Q 1/40

(52) U.S. Cl. 343/873

(57) ABSTRACT

A wireless card includes a body, a circuit device and an adjustable antenna assembly. The body includes an insertion portion and an outer portion. The outer portion is connected to an end of the insertion portion. The circuit device is mounted inside the body. The adjustable antenna is adjustably mounted in the outer portion and includes an antenna module. The antenna module includes an inner base, an antenna, at least two molding supporting members and an outer casing. The antenna is attached to the inner base and connected electrically to the circuit device. The molding supporting members are formed on the inner base. The outer casing encapsulates the inner base with the antenna with embedded molding.

### BACKGROUND

1. Field of Invention

The present invention relates to a wireless mobile communications device. More particularly, the present invention relates to a wireless card for mobile communications.

2. Description of Related Art

Next generation mobile communications technologies and terminal equipment are continuously developed to satisfy the increasing demands of mobility. This mobile communication technology and terminal equipment seeks not only to improve communication speed and quality, but also to provide communication terminals that are convenient to use, look good and are portable to meet consumer demands.

Typically, portable information technology (IT) products, such as laptops require wireless cards to enable wireless communications. Wireless cards have various designs and features based on the specifications of different wireless communication protocols. Developments and growth of the next generation mobile communications technologies increase communication quality and data transmission speed.

Recently, major mobile communication technologies focus on accelerating data transmission speed and improving data transmission quality. Several major mobile communication protocols, such as globe system for mobile communications (GSM) of second generation (2G) standards, general packet radio service (GPRS) of 2.5G standards, wideband code division multiple access (WCDMA) of 3G standards and even recent high speed downlink packet access (HSDPA) of 3.5G standards have been developed and continuously improved to substantially accelerate the transmission speed.

Generally, the wireless cards use antennas to receive and transmit wireless signals. Antenna dimension, size and location are major design challenges that influence the performance of signal reception and transmission. Further, different countries adopt different mobile communication technologies and different band frequencies. User environment of the portable electronic device is varied following the mobility of the user. Thus, using a single antenna does not satisfy the requirements of good signal reception and transmission.

Consequently, recent wireless cards provide several built-in or adjustable antennas. When pivoting operations spread the adjustable, the exposed surface of the adjustable antenna must be a smooth and clean surface to provide a nice appearance. In other words, the exposed surface of the adjustable antenna cannot have any parting lines or boundary lines between components to meet surface quality requirements.

In addition, the adjustable antenna has an antenna inside. Position deviations of the antenna inside the adjustable antenna significantly influence the signal reception and transmission quality. Therefore, there is a need to have supporting components hold the antenna in position during the molding process when the adjustable antenna is manufactured to prevent the antenna from being pushed and moved by the flow of injection plastic material.

Therefore, there is a need to provide an improved wireless card to mitigate or obviate the aforementioned problems.

### SUMMARY

An object of the present invention is to provide a wireless card, and the wireless card comprises an adjustable antenna with smooth and clean appearance, and the adjustable antenna has an antenna positioned precisely inside.

Another object of the present invention is to provide an adjustable antenna for a wireless card so that the entire appearance of the wireless card is good look, which enhances signal reception and transmission quality and to increase manufacturing yield of the wireless card.

A wireless card comprises a body, a circuit device, a transmission interface, and an adjustable antenna. The body comprises an insertion portion and an outer portion. The insertion portion has a first end and a second end opposite to the first end. The outer portion is connected to the second end. The circuit device is mounted inside the body. The transmission interface is connected to the first end of the body and is electrically connected to the circuit device. The adjustable antenna is adjustably mounted on the outer portion and comprises an antenna module.

The antenna module comprises an inner base, an antenna, at least two molding supporting members and an outer casing. The antenna is attached to the inner base and is electrically connected to the circuit device. Then at least two molding supporting members are mounted on the inner base. The outer casing encapsulates the inner base and the antenna.

In a preferred embodiment, at least two molding supporting members comprise a first molding supporting member and a second molding supporting member. The first molding supporting member is a recess defined in the inner base. The second molding supporting member is a metal tube. The metal tube is mounted on the inner base and comprises at least one clamping surface exposed outside the inner base.

In a preferred embodiment, the inner base comprises a through hole, and the metal tube is partially mounted and held in the through hole. The antenna module further comprises a conducting cord, and the conducting cord passes through and holds the metal tube with its two ends respectively and is electrically connected to the antenna and the circuit device.

Consequently, when forming the outer casing an embedded molding can fabricate the adjustable antenna. Since the molding supporting members support the antenna module in two separate positions to suspend the antenna module in mold cavities, the antenna module will not move or deviate when the injection plastic injects into the mold cavities where the antenna module is suspended. The antenna is precisely held in a desired relative position inside the outer casing to satisfy high quality communication requirements after the outer casing is formed.

In addition, since the antenna and the inner base are encapsulated by the outer casing with embedded molding, the appearance of the adjustable antenna does not have any component boundary lines, i.e. the lines between the adjacent components. Thus, the complete appearance of the adjustable antenna is smooth, clean and nice to look at.

Furthermore, using the multi-stage embedded molding to manufacture the adjustable antenna not only increases manufacturing yield, but also enhances stabile of manufacturing processes.

### BRIEF DESCRIPTION OF THE DRAWINGS

These and other features, aspects, and advantages of the present invention will become better understood with regard to the following description, appended claims, and accompanying drawings where:

FIG. 1 is a perspective view of a wireless card in accordance with the present invention;

FIG. 2 is an exploded perspective view of an adjustable antenna of the wireless card in FIG. 1;

FIG. 3 is a plan view of the adjustable antenna in FIG. 2;

FIG. 4 is a bottom perspective view of the adjustable antenna in FIG. 2;

FIG. 5 is an exploded perspective view of an antenna module of the adjustable antenna in FIG. 2;

FIG. 6 is an exploded perspective view of the antenna module in FIG. 5; and

FIG. 7 is a plan view of the antenna module in FIGS. 5.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

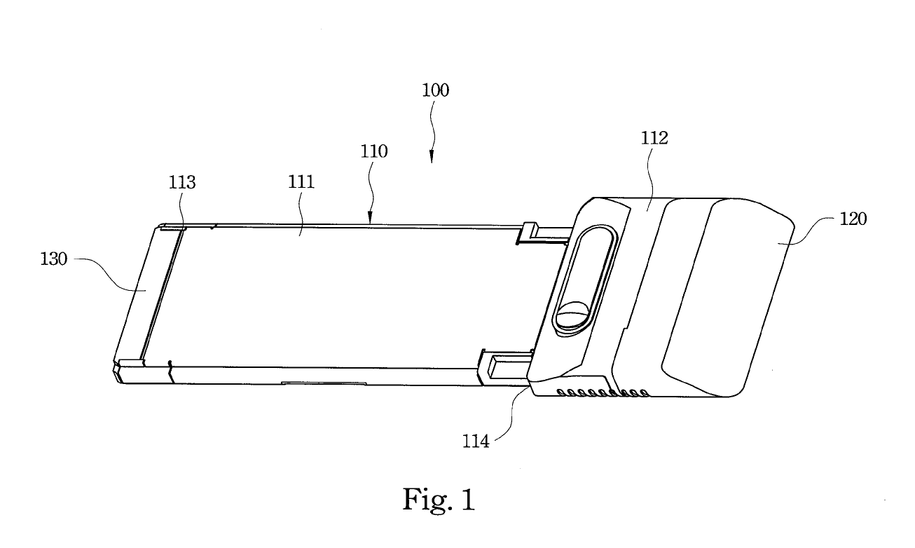

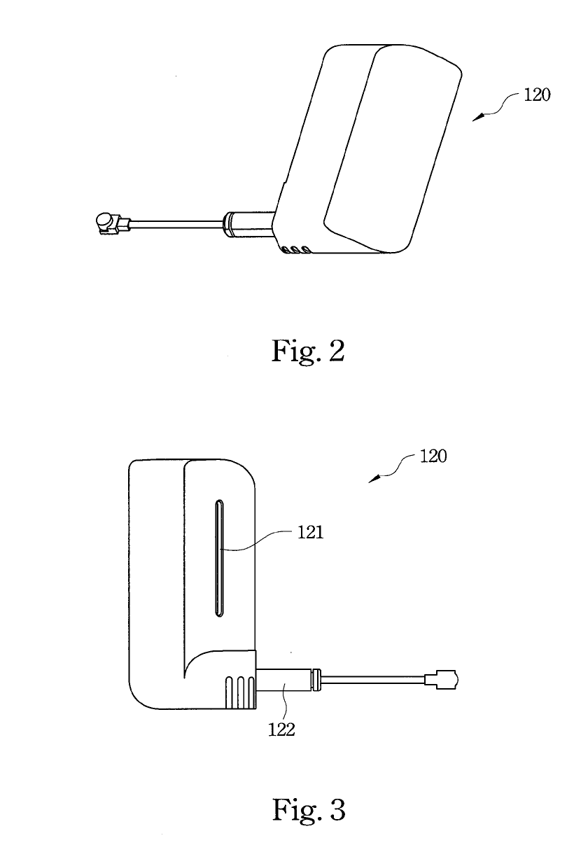

Refer to FIG. 1 and FIG. 2. An embodiment of a wireless card 100 in accordance with the present invention comprises a body 110, an adjustable antenna 120, a transmission interface 130 and a circuit device. The body 110 comprises an insertion portion 111 and an outer portion 112. The circuit device is mounted inside the body 110.

The insertion portion 111 has a first end 113 and a second end 114 opposite to the first end 113. The transmission interface 130 is connected to the first end 113 and is electrically connected to the circuit device. When the wireless card 100 is used to establish wireless communication, the insertion portion 111 is inserted into a slot of a portable electronic device (such as a laptop) until the transmission interface 130 electrically connects to the portable electronic device. The transmission interface 130 may be an express card transmission interface, a universal serial bus (USB) transmission interface, a personal computer memory card international association (PCMCIA) transmission interface, or a compact flash (CF) card transmission interface.

The outer portion 112 is mounted on the second end 114 of the insertion portion 111. Further, the outer portion 112 holds a portion of the circuit device inside. The adjustable antenna 120 is adjustably mounted on the outer portion 112 and is electrically connected to the circuit device. The adjustable antenna 120 may be adjusted by pivoting it relative to the outer portion 112 to change its orientation.

Further, one or more built-in antennas may be mounted on the portion of the circuit device inside the outer portion 112. The built-in antennas are incorporated with the adjustable antenna 120 to provide multi-band and multi-path radio reception and transmission capabilities for the wireless card 100.

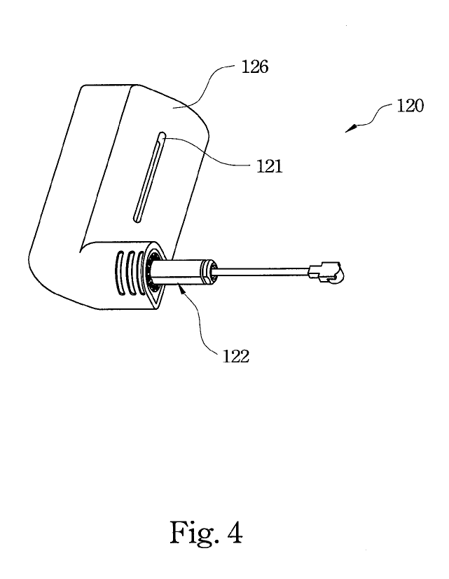

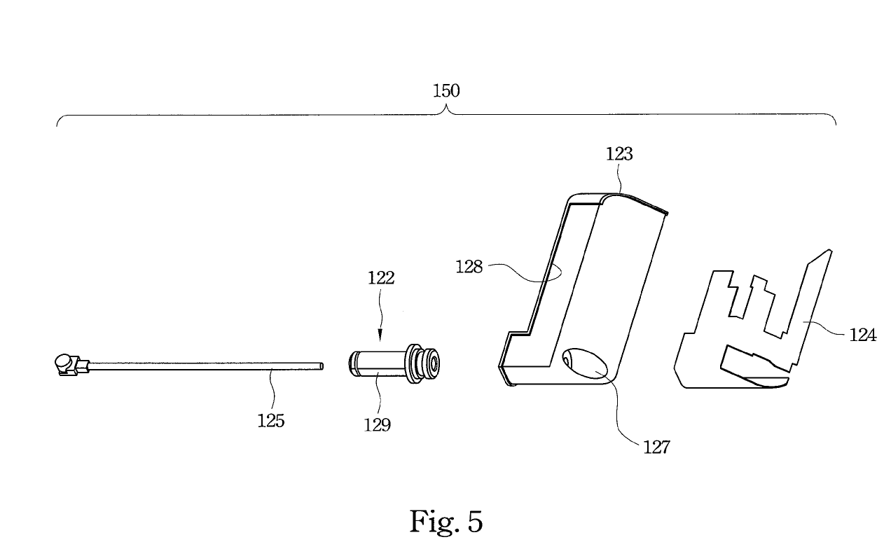

Refer to FIG. 3, FIG. 4 and FIG. 5. The adjustable antenna 120 comprises two or more molding supporting members. In this embodiment, the adjustable antenna 120 has a first molding supporting member 121 and a second molding supporting member 122, and comprises an antenna module 150 and an outer casing 126. The first molding supporting member 121 incorporates with the second molding supporting member 122 to hold the antenna module 150 in position in the molding cavities while molding the outer casing 126. The molding supporting members 121 and 122 provide a stable, firm and balanced support for the antenna module 150 in the molding cavities to prevent the injection plastic from pushing and moving the antenna module 150 form its desired position in the molding cavities.

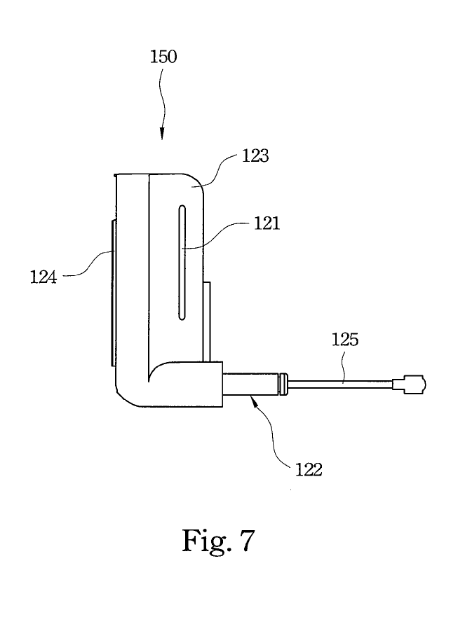

Refer to FIG. 7. The antenna module 150 comprises an inner base 123, an antenna 124, and a conducting cord 125. The inner base 123 has a through hole 127 and a flange 128. Further, the first molding supporting member 121 is formed in the inner base 123 and is implemented with a recess 121 in the illustrative embodiment. The recess 121 is an elongated hole. Thus, the molds can have an inserting member that protrudes from the mold wall of the mold cavities. Inserting the inserting member into the recess 121 provides a first supporting point for the inner base 123 in the mold cavities.

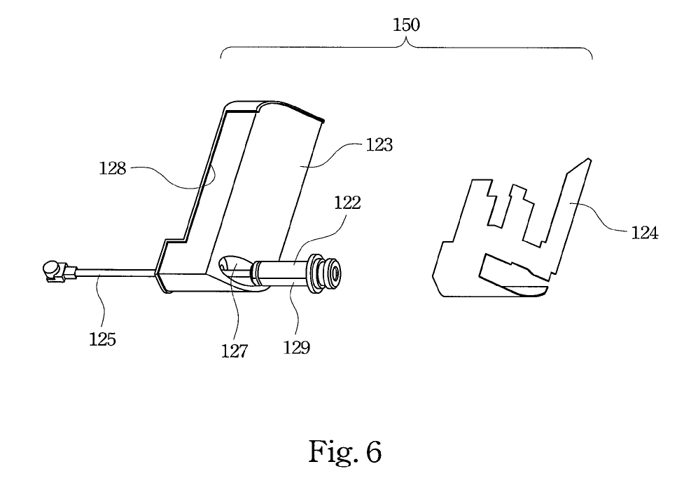

Reference is made to FIG. 5, FIG. 6 and FIG. 7. The through hole 127 is a stepped hole in which the second molding supporting member 122 is mounted and held. In this illustrative embodiment, the second molding supporting member 122 is a metal tube. The metal tube is partially mounted and held in the through hole 127. The second molding supporting member 122 has one or more than one clamping surface 129. The clamping surface 129 is a flat surface and is defined outside the through hole 127. Likewise, when the inner base 123 is put in the mold cavities, the molds clamp the second molding supporting member 122 through the clamping surface 129 so as to provide a second supporting point for the inner base 123.

The antenna 124 is made of metal and is attached to the inner base 123 by adhesive or hot melt adhesive. The antenna 124 is firmly secured on the inner base 123. The flange 128 of the inner base 123 positions the antenna 124 by abutting the antenna 124 against the flange 128.

The conducting cord 125 passes through and is held in the second molding supporting member 122 (the metal tube) with its two ends respectively extend out of the second molding supporting member 122. The ends of the conducting cord 125 are respectively and electrically connected to the antenna 124 and the circuit device inside the body 110.

Consequently, embedded molding can be used to fabricate the adjustable antenna 120. The antenna 124 is attached to the inner base 123, and then mounted on the second molding supporting member 122 in the through hole 127. Next the conducting cord 125 is passed through the second molding supporting member 122 and electrically connects one end of the conducting cord 124 to the antenna 124 to complete the assembly of the antenna module 150.

The antenna module 150 will be held in position in the mold cavities by means of the support effects provided by the first and the second molding supporting members 121 and 122. Finally, the injection plastic is injected into the mold cavities to form the outer casing 126 that encapsulates the inner base 123 and the antenna 124. Since the antenna module 150 is supported and suspended by the molding supporting members 121 and 122 at two separate positions, the antenna module 150 is not moved or does not deviate away from its desired position when the injection plastic is injected into the molds. The antenna 124 is held in a desired relative position inside the outer casing to satisfy high quality communication requirements.

In addition, since the antenna 124 and the inner base 123 are encapsulated by the outer casing 126 with the embedded molding, the complete appearance of the adjustable antenna 120 does not have any component boundary lines, i.e. the lines between the adjacent components. Thus, the appearance of the adjustable antenna 120 is smooth, clean and nice to look at.

Furthermore, using the multi-stage embedded molding to manufacture the adjustable antenna 120 not only increases manufacturing yield, but also enhances stability of manufacturing processes.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A wireless card comprising
a body comprising an insertion portion and an outer portion, the insertion portion having a first end and a second end opposite to the first end, and the outer portion connected to the second end;
a circuit device mounted in the body;
a transmission interface connected to the first end of the body and electrically connected to the circuit device; and
an adjustable antenna adjustably mounted on the outer portion and comprising an antenna module, and the antenna module comprising
an inner base;
an antenna attached to the inner base and electrically connected to the circuit device;
at least two molding supporting members formed on the inner base; and
an outer casing encapsulating the inner base and the antenna.

2. The wireless card as claimed in claim 1, wherein the at least two molding supporting members comprise a first molding supporting member and a second molding supporting member, and the molding supporting member is a recess defined in the inner base.

3. The wireless card as claimed in claim 2, wherein the second molding supporting member is a metal tube, the metal tube is mounted on the inner base and comprises at least one clamping surface exposed outside the inner base.

4. The wireless card as claimed in claim 2, wherein the recess is an elongated hole.

5. The wireless card as claimed in claim 1, wherein the inner base comprises a flange on which the antenna is abutted.

6. The wireless card as claimed in claim 3, wherein the inner base comprises a through hole, and the metal tube is partially mounted and held in the through hole.

7. The wireless card as claimed in claim 6, wherein the antenna module further comprises a conducting cord with two ends, and the conducting cord passes through and is held in the metal tube with its two ends respectively and electrically connected to the antenna and the circuit device.

8. The wireless card as claimed in claim 1, wherein the outer casing is formed by embedded molding.

9. An adjustable antenna for a wireless card, and the adjustable antenna comprising an antenna module, and the antenna module comprising
an inner base;
an antenna attached to the inner base and electrically connected to the circuit device;
at least two molding supporting members formed on the inner base; and
an outer casing encapsulating the inner base and the antenna.

10. The adjustable antenna as claimed in claim 9, wherein the at least two molding supporting members comprise a first molding supporting member and a second molding supporting member, and the molding supporting member is a recess defined in the inner base.

11. The adjustable antenna as claimed in claim 10, wherein the second molding supporting member is a metal tube, the metal tube is mounted on the inner base and comprises at least one clamping surface exposed outside the inner base.

12. The adjustable antenna as claimed in claim 10, wherein the recess is an elongated hole.

13. The adjustable antenna as claimed in claim 9, wherein the inner base comprises a flange on which the antenna is abutted.

14. The adjustable antenna as claimed in claim 12, wherein the inner base comprises a through hole, and the metal tube is partially mounted and held in the through hole.

15. The adjustable antenna as claimed in claim 14, wherein the antenna module further comprises a conducting cord, and the conducting cord passes through and held in the metal tube and has an end electrically connected to the antenna.

16. The adjustable antenna as claimed in claim 9, wherein the outer casing is formed by embedded molding.

17. The adjustable antenna as claimed in claim 11, wherein the at least one clamping surface is flat, and the antenna is made of metal.
